(19) United States
(12) Patent Application Publication
(10) Pub. No.: US 2015/0280580 A1
(43) Pub. Date: Oct. 1, 2015

(54) POWER CONVERSION APPARATUS

(71) Applicant: HEP TECH CO., LTD., Taichung City (TW)

(72) Inventors: PO-YEN CHEN, Taipei City (TW); CHING-TSAI PAN, Hsinchu City (TW); TA- SHENG Hung, Taichung City (TW)

(21) Appl. No.: 14/666,657

(22) Filed: Mar. 24, 2015

Related U.S. Application Data
(63) Continuation-in-part of application No. 14/324,722, filed on Jul. 7, 2014.

(30) Foreign Application Priority Data
Mar. 28, 2014 (TW) 103111703
Feb. 6, 2015 (TW) 104104123

(51) Int. Cl. H02M 3/335

(52) U.S. Cl. CPC H02M 3/33507

(57) ABSTRACT

A power conversion apparatus, which converts power of a DC power supply and provides it to a plurality of loadings, includes a transformer, an electronic switch, a leakage energy recycling circuit, and a plurality of output circuits. The transformer has a plurality of primary windings, which receives the power, and a plurality of secondary windings, which outputs the converted power. One end of the electronic switch is electrically connected to the primary windings; the other end thereof is electrically connected to the DC power supply. The leakage energy recycling circuit is electrically connected to the primary windings, and repeatedly and alternatively outputs the powers of positive and negative voltage. The circuit receives and stores leakage energy of the transformer, and feedbacks it to the transformer. The output circuits are electrically connected to the secondary windings to receive the converted power and to provide it to the loadings.

### CROSS-REFERENCE TO RELATED APPLICATION

This application is a continuation-in-part application of U.S. application No. 14/324,722 filed on Jul. 7, 2014 and claiming priority from Taiwan patent application No. 103111703 filed on Mar. 28, 2014 and Taiwan patent application No. 104104123 filed on Feb. 6, 2015.

### BACKGROUND OF THE INVENTION

1. Field of the Invention

The present invention relates generally to power conversion, and more particularly to a power conversion apparatus capable of converting the power of a power supply to provide the converted power for a plurality of loadings.

2. Description of the Related Art

Typically, a conventional power conversion apparatus converts power with a transformer and other electronic components, and while the transformer works, it would generate corresponding magnetizing inductance and leakage energy, wherein leakage energy is a natural phenomenon which happens due to incomplete coupling of magnetic flux between the primary and secondary windings of the transformer. With wider air gap between the primary winding and the secondary winding, the coupling coefficient of the transformer becomes lower, which generates more leakage energy.

In fact, the leakage energy of a transformer can be seen as the parasitic inductance of an equivalent parasitic inductor which is in-series connected to an equivalent inductor of the primary winding. Therefore, while a transformer works, the energy stored in the equivalent inductor of the primary winding is transferred to the secondary winding and the loading, but the energy stored in the leakage energy has no circuit path to go, which causes enormous voltage spikes on other components of the circuit. Therefore, there usually is an additional buffer circuit applied in a transformer to absorb and consume the leakage energy. But such buffer circuit may reduce the performance of the transformer.

However, for those power conversion apparatuses applied in wireless power transmission systems, the coupling coefficient would be greatly lowered with wider air gaps, and as a result, there would be much more leakage energy generated. In such cases, the aforementioned design of buffer circuits would not only greatly reduce the performance of the transformer, but also generate great amount of waste heat due to absorbing and consuming the leakage energy. The lifespans of the transformer itself and other components of the circuit tend to be shortened because of high temperature.

Moreover, due to the above reasons, the energy transmission range of the conventional power conversion apparatus is very small; therefore, the conventional power conversion apparatus can transmit power to the loading only when the loading is very close to the conventional power conversion apparatus rather than transmit power to the whole plane. Thus, the conventional power conversion apparatus will not be able to transmit power to several loadings when these loadings are stacked. Obviously, the performance of the conventional power conversion apparatus cannot be effectively improved and its application is also limited.

Therefore, it has become an important issue to provide a power conversion apparatus capable of solving the problems that the conventional power conversion apparatus has low efficiency, short lifespan, poor performance and limited application.

### SUMMARY OF THE INVENTION

Therefore, it is one of the primary objectives of the present invention to provide a power conversion apparatus in order to solve the problems that the conventional power conversion apparatus has low efficiency, short lifespan, poor performance and limited application.

To achieve the foregoing objective, the present invention provides a power conversion apparatus, which may convert the power of a DC power supply and provide the converted power to a plurality of loadings. The apparatus may comprise a transformer, an electronic switch, a first inductor, a first capacitor and a plurality of output circuits. The transformer may have a plurality of primary windings and a plurality of secondary windings, wherein the primary windings may receive the power of the DC power supply and may have an equivalent primary inductor and an equivalent leakage inductor, while the secondary windings may output the converted power. The electronic switch may either allow the power of the DC power supply to flow to the primary windings or cuts off the power, wherein the electronic switch may have two ends; one of which may be electrically connected to the primary windings and the other of which may be electrically connected to the DC power supply. The first inductor may be electrically connected to the primary windings. The first capacitor may be electrically connected to the primary windings, and also connected to the first inductor in parallel, wherein the first capacitor may receive and store leakage energy of the equivalent leakage inductor of the primary windings, and may form a resonant circuit with the first inductor to feedback the leakage energy to the transformer, which may repeatedly and alternatively reverse the polarity of the voltage drop of the first capacitor. A plurality of output circuits may be respectively electrically connected to the secondary windings to receive the converted power from the transformer, wherein each of the output circuits may have a second capacitor, and the two ends of the second capacitor may be respectively electrically connected to two ends of one of the loadings to provide the converted power to the loadings.

In a preferred embodiment of the present invention, the primary windings may be connected to each other in parallel to increase the energy transmission range of the primary windings, and each of the primary windings may have a first end and a second end; the positive terminal of the DC power supply may be electrically connected to the first end; one of the two ends of the electronic switch may be electrically connected to the second end of the primary winding, while the other end of the electronic switch may be electrically connected to the negative terminal of the DC power supply; the first inductor and the first capacitor both may have two ends, wherein one end of the first inductor and one end of the first capacitor may be both electrically connected to the first end of the primary winding, while the other end of the first inductor and the other end of the first capacitor may be both electrically connected to the second end of the primary winding.

In a preferred embodiment of the present invention, the power conversion apparatus may further include a first diode, wherein the first diode has two ends, one of which is electrically connected to the first capacitor and the first inductor, while the other of which is electrically connected to the transformer, and therefore the first capacitor and the first inductor are electrically connected to the transformer through the first diode.

In a preferred embodiment of the present invention, the anode of the first anode may be electrically connected to the transformer, and the cathode of the first diode may be electrically connected to the first capacitor and the first inductor.

In a preferred embodiment of the present invention, the power conversion apparatus may further include a plurality of second diodes, wherein each of the second diodes may have two ends, one of which may be electrically connected to the transformer, while the other of which may be electrically connected to the output circuit, whereby the transformer may be electrically connected to the output circuits through the second diodes.

In a preferred embodiment of the present invention, the anodes of the second diodes may be electrically connected to the transformer and the cathodes of the second diodes may be respectively connected to the output circuits.

In a preferred embodiment of the present invention, each of the secondary windings may have a third end and a fourth end; each of the output circuits may further include a third diode, a third capacitor, and a second inductor; the anode of the third diode may be electrically connected to the fourth end, and the cathode of the third diode may be electrically connected to the third end; each of the third capacitors may have two ends, one of which may be electrically connected to the cathode of the third diode, while the other of which may be electrically connected to the second capacitor and the loading; the second inductor may have two ends, one of which may be electrically connected to the third capacitor, the second capacitor, and the loading, while the other of which may be electrically connected to the cathode of the third diode.

In a preferred embodiment of the present invention, each of the output circuits may further include a fourth diode having two ends, one of which may be electrically connected to the cathode of the third diode, while the other of which may be electrically connected to the second inductor, whereby the second inductor may be electrically connected to the cathode of the third diode through the fourth diode.

In a preferred embodiment of the present invention, the anode of each of the fourth diodes may be electrically connected to the cathode of the third diode, and the cathode of each of the fourth diodes may be electrically connected to the second inductor.

In a preferred embodiment of the present invention, the electronic switch may include a MOSFET and a body diode; the source and the drain of the MOSFET may be respectively electrically connected to the DC power supply and the transformer; the body diode may have two ends respectively electrically connected to the source and the drain.

To achieve the foregoing objective, the present invention further provides a power conversion apparatus, which may convert the power of a DC power supply and provide the converted power to a plurality of loadings. The power conversion apparatus may include a transformer, an electronic switch, a leakage energy recycling circuit and a plurality of output circuits. The transformer may have a plurality of primary windings and a plurality of secondary windings, wherein the primary windings may receive the power of the DC power supply and have an equivalent primary inductor and an equivalent leakage inductor, while the secondary windings may output the converted power; the primary windings may be connected to each other in parallel to increase an energy transmission range of the primary windings. The electronic switch may either allow the power of the DC power supply to flow to the primary windings or cut off the power, wherein the electronic switch may have two ends; one of which may be electrically connected to the primary windings and the other of which may be electrically connected to the DC power supply. The leakage energy recycling circuit may be electrically connected to the primary winding to receive and store leakage energy of the equivalent leakage inductor of the primary winding, and also to feedback the leakage energy to the transformer, wherein the leakage energy recycling circuit may repeatedly and alternatively output the powers of positive voltage and negative voltage. The output circuits may be respectively electrically connected to the secondary windings to receive the converted power from the transformer, and to provide the converted power to the loadings.

The power conversion apparatus according to the present invention has the following advantages:

(1) In one embodiment of the present invention, the power conversion apparatus uses the leakage energy recycling circuit to receive and store the leakage energy, and then feedback which to the transformer, so the energy transmission range of the power conversion apparatus can extend to the whole plane; therefore, the performance of the power conversion apparatus can be effectively enhanced.

(2) In one embodiment of the present invention, the power conversion apparatus uses the leakage energy recycling circuit to receive and store the leakage energy instead of a buffer circuit, so the efficiency of the transformer will be not reduced by the buffer circuit and the waste heat due to the buffer circuit will no longer be generated, too.

(3) In one embodiment of the present invention, the power conversion apparatus can transmit energy via a plurality of primary windings, so the power conversion apparatus can exactly transmit energy to all loadings even if these loadings are stacked. Therefore, the performance of the power conversion apparatus can be significantly enhanced.

(4) In one embodiment of the present invention, the design of the power conversion apparatus is favorable for modularization; thus, it is possible to achieve higher power transmission range by connecting multiple power conversion apparatuses rather than manufacturing a transformer with a large winding. In this way, the cost can be effectively reduced and the application can be more flexible, so the power conversion apparatus can have higher commercial value.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the schematic view of the first embodiment of the power conversion apparatus in accordance with the present invention.

FIG. 2 is the first schematic view of the second embodiment of the power conversion apparatus in accordance with the present invention.

FIG. 3 is the second schematic view of the second embodiment of the power conversion apparatus in accordance with the present invention.

FIG. 4 is the third schematic view of the second embodiment of the power conversion apparatus in accordance with the present invention.

FIG. 5 is the fourth schematic view of the second embodiment of the power conversion apparatus in accordance with the present invention.

FIG. 6 is the fifth schematic view of the second embodiment of the power conversion apparatus in accordance with the present invention.

FIG. 7 is the schematic view of the third embodiment of the power conversion apparatus in accordance with the present invention.

FIG. 8 is the schematic view of the fourth embodiment of the power conversion apparatus in accordance with the present invention.

### DETAILED DESCRIPTION OF THE PREFERRED EMBODIMENTS

The technical content of the present invention will become apparent by the detailed description of the following embodiments and the illustration of related drawings as follows.

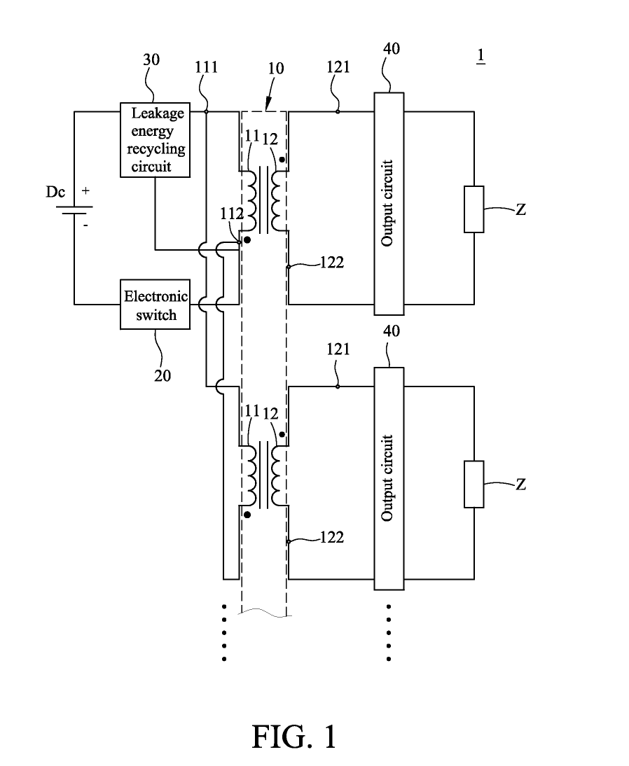

Please refer to FIG. 1, which is the schematic view of the first embodiment of the power conversion apparatus in accordance with the present invention. As shown in FIG. 1, the power conversion apparatus 1 is able to convert power of a direct current (DC) power supply Dc, and provide the converted power to a plurality of loadings Z. The power conversion apparatus 1 may include a transformer 10, an electronic switch 20, a leakage energy recycling circuit 30, and a plurality of output circuits 40.

The transformer 10 may include a plurality of primary windings 11 and a plurality of secondary windings 12, wherein the primary windings 11 may receive the power of the DC power supply Dc, and the secondary windings 12 may output the converted power. These primary windings 11 may be connected to each other in parallel to increase the energy transmission range. One end of the electronic switch 20 may be electrically connected to the primary windings 11; the other end of the electronic switch 20 may be electrically connected to the DC power supply Dc; the electronic switch 20 may either allow the power of the DC power supply Dc to flow to the primary windings 11 or cut off the power. The leakage energy recycling circuit 30 may be electrically connected to the primary windings 11, and repeatedly and alternatively outputs the powers of positive and negative voltage. The circuit may receive and store the leakage energy of the transformer, and may feedback it to the transformer 10. The output circuits 40 may be respectively electrically connected to the secondary windings 12 to receive the converted power and to provide it to the loadings Z.

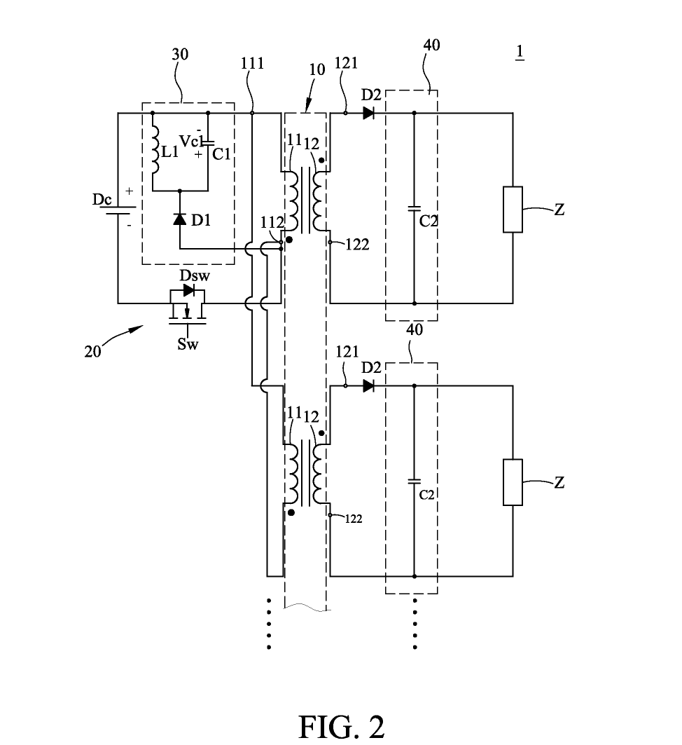

Please refer to FIG. 2, which is the first schematic view of the second embodiment of the power conversion apparatus in accordance with the present invention. FIG. 2 illustrates a preferred embodiment of the first embodiment of the power conversion apparatus 1 according to the present invention. As shown in FIG. 2, the power conversion apparatus 1 may include a transformer 10, an electronic switch 20, a leakage energy recycling circuit 30, and a plurality of output circuits 40.

The transformer 10 may include a plurality of primary windings 11 and a plurality of secondary windings 12, and each of the primary windings 11 may have a first end 111 and a second end 112, wherein the primary windings 11 may be connected to each other in parallel to increase the energy transmission range; each of the secondary windings 12 may have a third end 121 and a fourth end 122, wherein the first end 111 of the primary winding 11 is electrically connected to the positive terminal of the DC power supply Dc. In the preferred embodiment, the transformer 10 may be flyback transformer.

The electronic switch 20 may have two ends one end of which may be electrically connected to the primary windings 11 and the other end of which may be connected to the DC power supply Dc, whereby the electronic switch 20 may either allow the power of the DC power supply Dc to flow to the primary windings 11 or cuts off the power. In more details, the actual structure of the electronic switch 20 may include a metal oxide semiconductor field effect transistor (MOSFET) Sw and a body diode Dsw, wherein the source of the MOSFET Sw may be electrically connected to the negative terminal of the DC power supply Dc, and the drain thereof may be electrically connected to the second end 112 of the transformer 10. The anode and the cathode of the body diode Dsw may be respectively electrically connected to the source and the drain of the MOSFET Sw.

The leakage energy recycling circuit 30 may include a first inductor L1, a first capacitor C1, and a first diode DE wherein the first inductor L1 and the first capacitor C1 may be electrically connected to each other in parallel. The first inductor L1 and the first capacitor C1 both have two ends, wherein one end of each may be both electrically connected to the first end 111 and the positive terminal of the DC power supply Dc, and the other end of each may be both electrically connected to the cathode of the first diode D1, while the anode of the first diode D1 may be electrically connected to the second end 112 and the drain of the MOSFET Sw.

Each of the output circuits 40 may be electrically connected to one of the secondary windings 12 to receive the converted power from the transformer 10, wherein each of the output circuits 40 may have a second capacitor C2. The second capacitor C2 and the loading Z may be electrically connected to each other in parallel, wherein the end of the second capacitor C2 may be electrically connected to the fourth end 122, and the other end of the second capacitor C2 may be electrically connected to the third end 121 through a second diode D2. More specifically, the anode of the second diode D2 may be electrically connected to the third end 121, and the cathode thereof may be electrically connected to the second capacitor C2. Therefore, the second capacitor C2 may be electrically connected to the secondary winding 12 of the transformer 10 through the second diode D2.

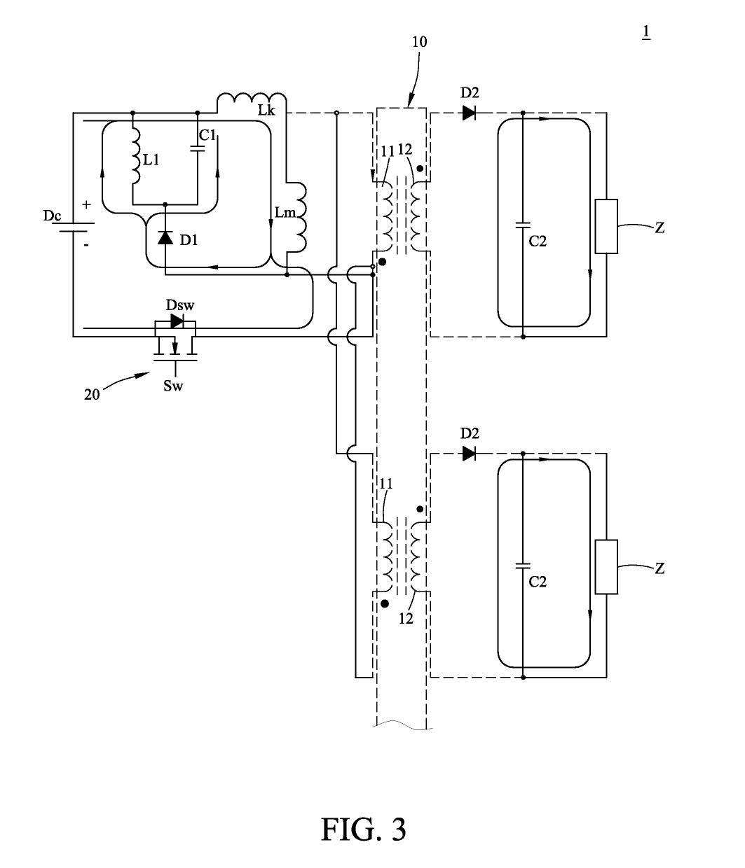

Please refer to FIG. 2 and FIG. 3; FIG. 3 is the second schematic view of the second embodiment of the power conversion apparatus in accordance with the present invention. With the aforementioned design, while the power conversion apparatus 1 is in operation, the primary windings 11 of the transformer 10 can be seen as an equivalent primary inductor Lm and an equivalent leakage inductor Lk connected to each other in series.

As shown in FIG. 3, when the electronic switch 20 allows the power of the DC power supply Dc to flow to the primary windings 11, the energy is stored in the equivalent primary inductor Lm and the equivalent leakage inductor Lk of the primary windings 11 through the electronic switch 20; at the same time, the second capacitor C2 may release energy to the corresponding loading Z. The first diode D1 may prevent the DC power supply Dc from directly charging the first capacitor C1 and the first inductor L1, and the second diode D2 may prevent the energy stored in the second capacitor C2 from being transmitted back to the transformer 10. The accuracy of the circuit can be ensured in this way.

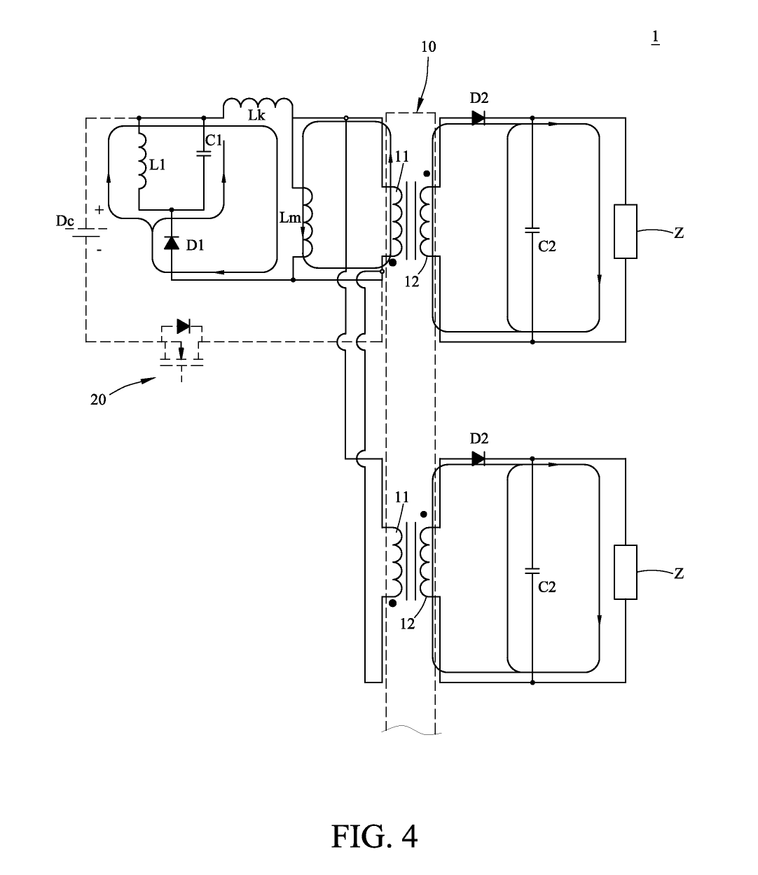

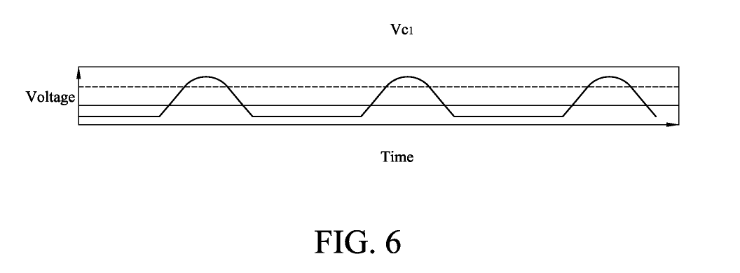

Please refer to FIG. 4 and FIG. 6; FIG. 4 is the third schematic view of the second embodiment of the power conversion apparatus in accordance with the present invention and FIG. 6 is the fifth schematic view of the second embodiment of the power conversion apparatus in accordance with the present invention. As shown in FIG. 4, when the electronic switch 20 cuts off the power of the DC power supply Dc, the energy stored in the equivalent primary inductor Lm may be transferred to the secondary windings 12 to be stored in the second capacitor C2 of each of the output circuit 40 through the second diodes D2, and then provided to the corresponding loading Z. Meanwhile, the energy stored in the equivalent leakage inductor Lk may be transferred to a resonant circuit formed by the first capacitor C1 and the first inductor L1 through the first diode D1, wherein the first capacitor C2 may receive and store leakage energy of the equivalent leakage inductor Lk of the transformer 10, which can avoid enormous voltage spike generated on the electronic switch 20. After that, the equivalent primary inductor Lm may release energy, and the resonant circuit formed by the first capacitor C1 and the first inductor L1 may start to react. As a result, the stored energy of the first inductor L1 may be converted into inductive current to charge the first capacitor C1. Consequently, the polarity of the voltage drop of the first capacitor C1 may be reversed, as shown in FIG. 6, to conduct the body diode Dsw of the electronic switch 20.

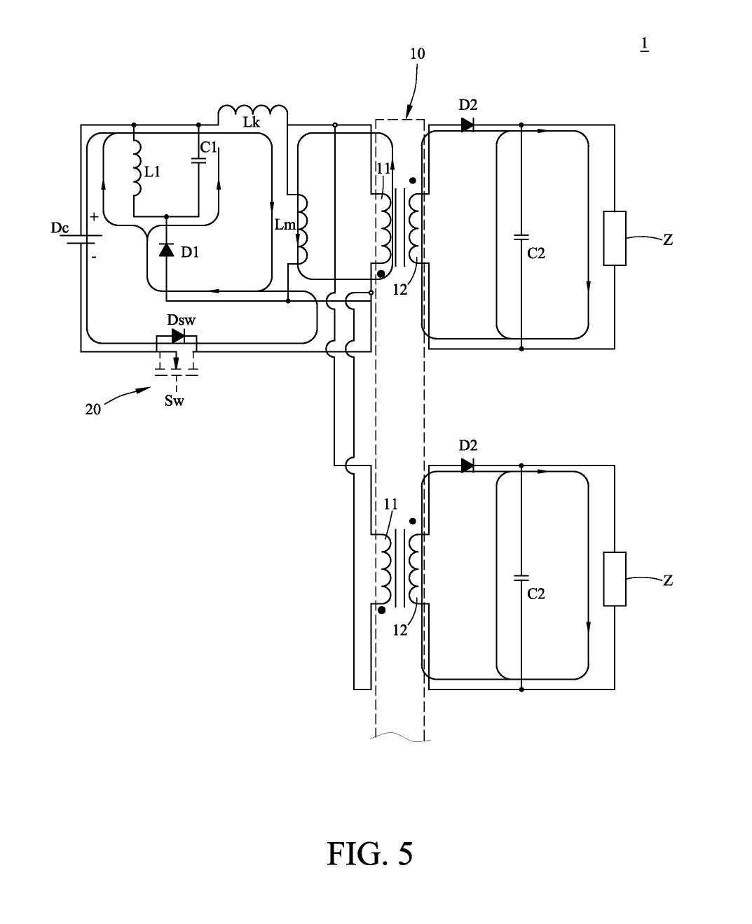

Please refer to FIG. 5, which is the fourth schematic view of the second embodiment of the power conversion apparatus in accordance with the present invention. As shown in FIG. 5, when the body diode Dsw of the electronic switch 20 is conducted, the resonant circuit formed by the first capacitor C1 and the first inductor L1 may start to transmit the stored energy to the primary windings 11 of the transformer 10, and therefore the equivalent primary inductor Lm keeps releasing energy, until the electronic switch 20 allows the power to flow through again. At this time point, the status of these components may be back to what is shown in FIG. 3, and the whole process described here may be defined as a cycle. Therefore, if the power conversion apparatus keeps working, the cycle may go on and on, unless the power conversion apparatus stops working.

As described above, with the aforementioned design of the leakage energy recycling circuit 30, the whole circuit structure of the body diode Dsw may be changed before and after the power being allowed to flow through during each cycle, which may make the polarity of the voltage drop of the first capacitor C1 get repeatedly and alternatively reserved. In this way, the leakage energy recycling circuit 30 may repeatedly and alternatively output the powers of positive and negative voltage. Hence the leakage energy of the transformer 10 can be received and stored, and then feedbacked back to the transformer 10. The consumption of the leakage inductance of the primary windings 11 can be reduced, and therefore enhances the power conversion efficiency of the transformer 10.

It is particularly noteworthy that the conventional power conversion apparatus needs to use a buffer circuit to consume the leakage energy, which will obviously reduce the efficiency of the transformer. On the contrary, one embodiment of the present invention can use a leakage energy recycling circuit to absorb the leakage energy rather than the buffer circuit; therefore, the efficiency of the transformer will not be influenced by the buffer circuit.

As described above, the conventional power conversion apparatus needs to use the buffer circuit to consume the leakage energy; however, the buffer circuit will generate a large amount of waste heat, which will reduce the lifespan of the power conversion apparatus. On the contrary, one embodiment of the present invention does not need the buffer circuit, so the waste heat will not be generated, which can effectively extend the lifespan of the power conversion apparatus.

Also, as the efficiency of the conventional power conversion apparatus is low, so its energy transmission range cannot extend to the whole plane. On the contrary, one embodiment of the present invention can use a leakage energy recycling circuit to absorb the leakage energy and then feedback which to the transformer, so the energy transmission range can extend to the whole plane; thus, the efficiency of the power conversion apparatus can obviously go up.

Besides, one embodiment of the present invention can use a plurality of primary windings to transmit energy at the same time; therefore, the energy transmission range of the apparatus can further extend. In this way, the power conversion apparatus can still effectively transmit energy to the loadings even if these loadings are stacked. Therefore, the performance of the power conversion apparatus can be significantly enhanced.

Furthermore, in one embodiment of the present invention, the design of the power conversion apparatus is favorable for modularization; thus, it is possible to achieve higher power transmission range by connecting multiple power conversion apparatuses rather than manufacturing a transformer with a large winding. In this way, the cost can be effectively reduced and the application can be more flexible, so the power conversion apparatus can have higher commercial value.

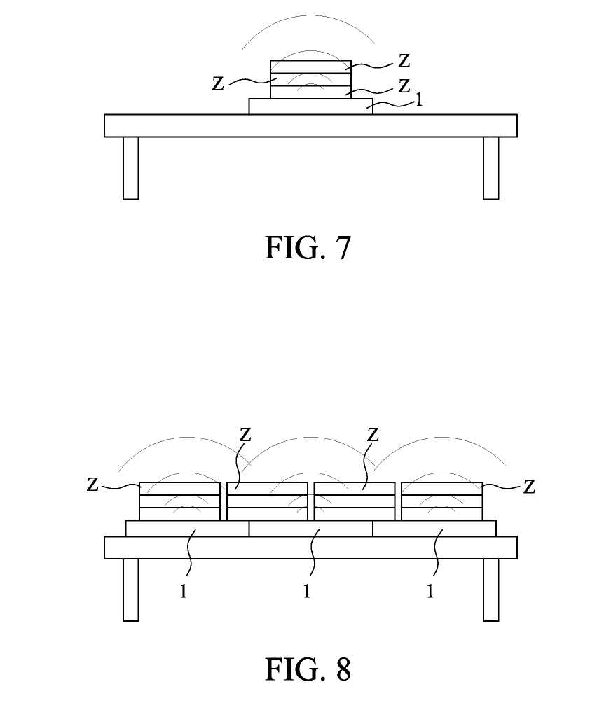

Please refer to FIG. 7, which is the schematic view of the third embodiment of the power conversion apparatus in accordance with the present invention. FIG. 7 illustrates the usage situation of one embodiment of the power conversion apparatus according to the present invention. As shown in FIG. 7, the power conversion apparatus 1 can use a plurality of primary windings to transmit energy at the same time; accordingly, the power conversion apparatus can still effectively transmit energy to the loadings Z even if these loadings Z are stacked. Therefore, the above design can effectively improve the performance of the power conversion apparatus 1.

Please refer to FIG. 8, which is the schematic view of the fourth embodiment of the power conversion apparatus in accordance with the present invention. FIG. 8 illustrates the usage situation of one embodiment of the power conversion apparatus according to the present invention. The design of the embodiment of the present invention is very favorable for modularization; thus, it is possible to achieve higher power transmission range by connecting several power conversion apparatuses rather than manufacturing a transformer with a large winding. In this way, the cost can be effectively reduced and the application is more flexible, so the power conversion apparatus can have higher commercial value.

In summation of the description above, in one embodiment of the present invention, the power conversion apparatus can use a leakage energy recycling circuit to receive and store the leakage energy, and then feedback which to the transformer, so the energy transmission range of the power conversion apparatus can further extend to the whole plane; therefore, the performance of the power conversion apparatus can be effectively enhanced.

In one embodiment of the present invention, the power conversion apparatus can use the leakage energy recycling circuit to receive and store the leakage energy instead of a buffer circuit, so the efficiency of the transformer will be not reduced by the buffer circuit and the waste heat due to the buffer circuit will no longer be generated, too.

Besides, in one embodiment of the present invention, the power conversion apparatus can transmit energy via a plurality of primary windings, which can significantly increase its energy transmission range, so the power conversion apparatus can exactly transmit energy to all loadings even if these loadings are stacked. Therefore, the performance of the power conversion apparatus can be significantly enhanced.

Moreover, in one embodiment of the present invention, the design of the power conversion apparatus is very favorable for modularization; thus, it is possible to achieve higher power transmission range by connecting multiple power conversion apparatuses rather than manufacturing a transformer with a large winding, which can reduce the cost and make the application more flexible, so the commercial value of the power conversion apparatus can be higher.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A power conversion apparatus, which converts power of a DC power supply and provides the converted power to a plurality of loadings, comprising:
a transformer having a plurality of primary windings and a plurality of secondary windings, wherein the primary windings receive the power of the DC power supply and have an equivalent primary inductor and an equivalent leakage inductor, while the secondary windings output the converted power;
an electronic switch which either allows the power of the DC power supply to flow to the primary windings or cuts off the power, wherein the electronic switch has two ends; one of which is electrically connected to the primary windings and the other of which is electrically connected to the DC power supply;
a first inductor electrically connected to the primary windings;
a first capacitor electrically connected to the primary windings, and also connected to the first inductor in parallel, wherein the first capacitor receives and stores leakage energy of the equivalent leakage inductor of the primary windings, and forms a resonant circuit with the first inductor to feedback the leakage energy to the transformer, which repeatedly and alternatively reverses a polarity of a voltage drop of the first capacitor; and
a plurality of output circuits respectively electrically connected to the secondary windings to receive the converted power from the transformer, wherein each of the output circuits has a second capacitor, which has two ends respectively electrically connected to two ends of one of the loadings to provide the converted power to the loadings.

2. The power conversion apparatus of claim 1, wherein the primary windings are connected to each other in parallel to increase an energy transmission range of the primary windings, and each of the primary windings has a first end and a second end; a positive terminal of the DC power supply is electrically connected to the first end; one of the two ends of the electronic switch is electrically connected to the second end of the primary winding, while the other end of the electronic switch is electrically connected to a negative terminal of the DC power supply; the first inductor and the first capacitor both have two ends, wherein one end of the first inductor and one end of the first capacitor are both electrically connected to the first end of the primary winding, while the other end of the first inductor and the other end of the first capacitor are both electrically connected to the second end of the primary winding.

3. The power conversion apparatus of claim 1, further comprising a first diode, wherein the first diode has two ends, one of which is electrically connected to the first capacitor and the first inductor, while the other of which is electrically connected to the transformer, and therefore the first capacitor and the first inductor are electrically connected to the transformer through the first diode.

4. The power conversion apparatus of claim 3, wherein an anode of the first anode is electrically connected to the transformer, and a cathode of the first diode is electrically connected to the first capacitor and the first inductor.

5. The power conversion apparatus of claim 1, further comprising a plurality of second diodes, wherein each of the second diodes has two ends, one of which is electrically connected to the transformer, while the other of which is electrically connected to the output circuit, whereby the transformer is electrically connected to the output circuits through the second diodes.

6. The power conversion apparatus of claim 5, wherein anodes of the second diodes are electrically connected to the transformer and cathodes of the second diodes are respectively connected to the output circuits.

7. The power conversion apparatus of claim 1, wherein each of the secondary windings has a third end and a fourth end; each of the output circuits further comprises a third diode, a third capacitor, and a second inductor; an anode of the third diode is electrically connected to the fourth end, and an cathode of the third diode is electrically connected to the third end;
each of the third capacitors has two ends, one of which is electrically connected to the cathode of the third diode, while the other of which is electrically connected to the second capacitor and the loading; the second inductor has two ends, one of which is electrically connected to the third capacitor, the second capacitor, and the loading, while the other of which is electrically connected to the cathode of the third diode.

8. The power conversion apparatus of claim 7, wherein each of the output circuits further comprises a fourth diode having two ends, one of which is electrically connected to the cathode of the third diode, while the other of which is electrically connected to the second inductor, whereby the second inductor is electrically connected to the cathode of the third diode through the fourth diode.

9. The power conversion apparatus of claim 8, wherein an anode of each of the fourth diodes is electrically connected to the cathode of the third diode, and a cathode of each of the fourth diodes is electrically connected to the second inductor.

10. The power conversion apparatus of claim 1, wherein the electronic switch comprises a MOSFET and a body diode; a source and a drain of the MOSFET are respectively electrically connected to the DC power supply and the transformer; the body diode has two ends respectively electrically connected to the source and the drain.

11. A power conversion apparatus, which converts power of a DC power supply and provides the converted power to a plurality of loadings, comprising:
a transformer having a plurality of primary windings and a plurality of secondary windings, wherein the primary windings receive the power of the DC power supply and have an equivalent primary inductor and an equivalent leakage inductor, while the secondary windings output the converted power; the primary windings are connected to each other in parallel to increase an energy transmission range of the primary windings;
an electronic switch either allowing the power of the DC power supply to flow to the primary windings or cuts off the power, wherein the electronic switch has two ends; one of which is electrically connected to the primary windings and the other of which is electrically connected to the DC power supply;
a leakage energy recycling circuit electrically connected to the primary winding to receive and store leakage energy of the equivalent leakage inductor of the primary winding, and also to feedback the leakage energy to the transformer, wherein the leakage energy recycling circuit repeatedly and alternatively outputs powers of positive voltage and negative voltage; and
a plurality of output circuits respectively electrically connected to the secondary windings to receive the converted power from the transformer, and to provide the converted power to the loadings.
